(19) United States
(12) Patent Application Publication
(10) Pub. No.: US 2022/0044218 A1
(43) Pub. Date: Feb. 10, 2022

(54) Payments Using Electronic Documents

(71) Applicant: Wells Fargo Bank, N.A., San Francisco, CA (US)

(72) Inventors: Joon Maeng, Newcastle, WA (US); Shivakumar Doddi, Hyderabad (IN); Ramanathan Ramanathan, Bellevue, WA (US)

(21) Appl. No.: 15/428,398

(22) Filed: Feb. 9, 2017

(51) Int. Cl. G06Q 20/10; G06K 7/14; G06Q 20/40

(52) U.S. Cl. CPC G06Q 20/102; G06Q 20/405; G06K 7/1417

(57) ABSTRACT

An example method for processing an electronic statement includes: receiving a biller identifier, the biller identifier being known to a payer; populating the biller identifier in the electronic statement, the electronic statement being an electronic document including financial information; encrypting the electronic statement including the biller identifier; sending the encrypted electronic statement including the biller identifier to the payer; and receiving authorization from the payer to make a payment identified in the electronic statement.

### BACKGROUND

Many financial documents, such as credit card statements and invoices, are delivered as electronic statements for payment. Individuals who receive such electronic statements may write paper checks or visit the web sites of the billing parties to make payments. These existing payment solutions can be inconvenient and insecure because the individuals are required to take several manual steps to make the payments.

### SUMMARY

Embodiments of the disclosure are directed to electronic documents and include systems and methods for providing payments through electronic documents.

In one example, a method for processing an electronic statement includes: receiving a biller identifier, the biller identifier being known to a payer; populating the biller identifier in the electronic statement, the electronic statement being an electronic document including financial information; encrypting the electronic statement including the biller identifier; sending the encrypted electronic statement including the biller identifier to the payer; and receiving authorization from the payer to make a payment identified in the electronic statement.

### DESCRIPTION OF THE DRAWINGS

FIG. 1 shows an example system that facilitates payments through electronic statements.

FIG. 2 shows an example logical representation of a portion of a payer computing device of the system of FIG. 1.

FIG. 3 shows an example electronic statement used in the system of FIG. 1.

FIG. 4 shows an example electronic bill payment document used in the system of FIG. 1.

FIG. 5 shows an example interface that automates the payment date of the electronic bill payment document used in the system of FIG. 1.

FIG. 6 shows an example method for using the electronic statement of the system of FIG. 1.

FIG. 7 shows an example structure of the electronic statement of the system of FIG. 1.

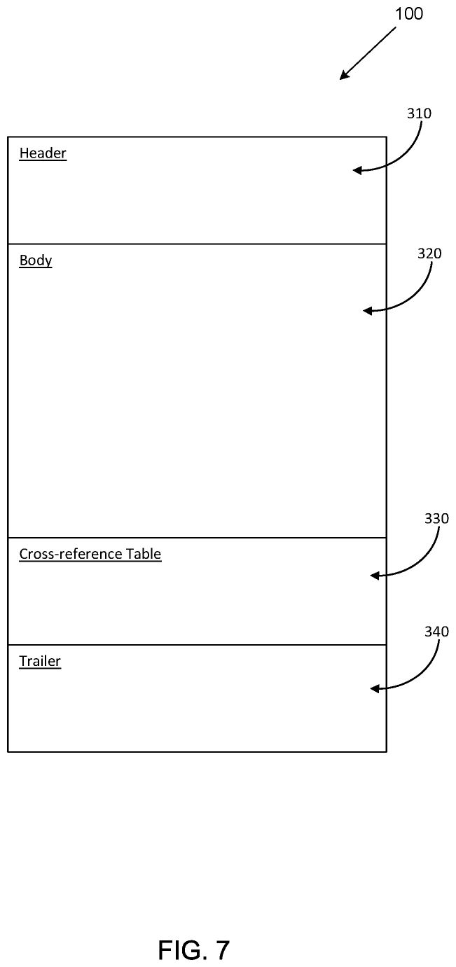

FIG. 8 shows example components of the biller computing device(s) of the system of FIG. 1.

### DETAILED DESCRIPTION

The present disclosure is directed to electronic documents and includes systems and methods for providing payments through electronic documents.

In one non-limiting example of these systems and methods, an entity sends an electronic statement associated with a financial transaction (e.g., an invoice or a credit card statement) to an individual for payment. The electronic statement can include a unique identifier and/or hidden metadata. The electronic statement can be, in turn, automatically processed by the sender's (e.g., biller's) computing system, recipient's (e.g., payer's) computing system and/or any other third party's computing system. This can include one or more of determining the authenticity of the electronic statement and automating the payment of the electronic statement using funds associated with the individual.

Using electronic statements programmed in this manner enables electronic statements to be processed without requiring excessive manual steps (e.g., visiting the biller web site to make payment or writing paper checks). The electronic statements can also provide added security and reliability due to the machine-to-machine nature of the transaction.

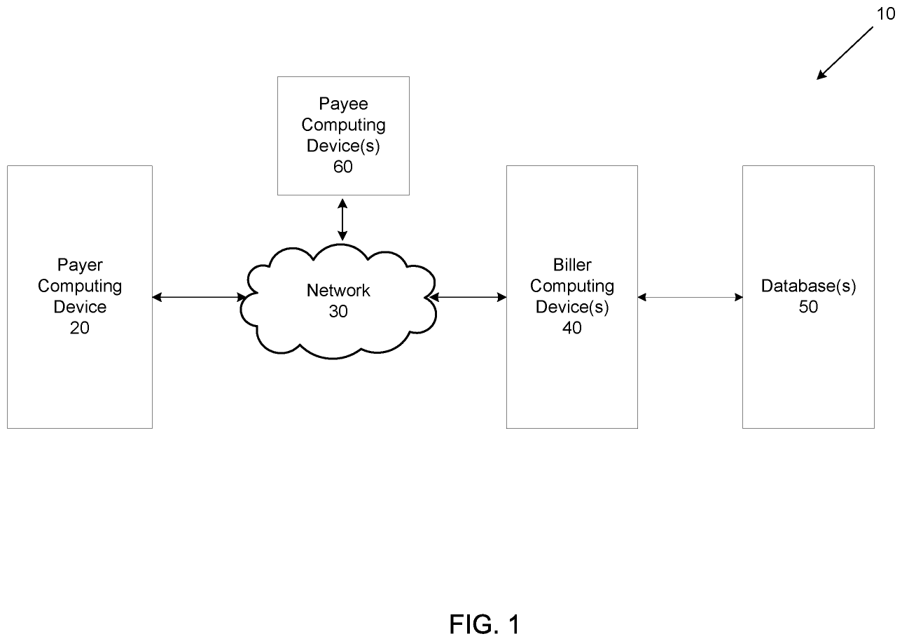

Referring now to FIG. 1, an example system 10 is shown that facilitates payments through electronic documents. In this example, the system 10 includes a payer computing device 20 used by a payer, biller computing device(s) 40 used by a biller, and payee computing device(s) 60 used by a payee. The various computing devices communicate with one another through a network 30, such as a local area network or a wide area network like the Internet.

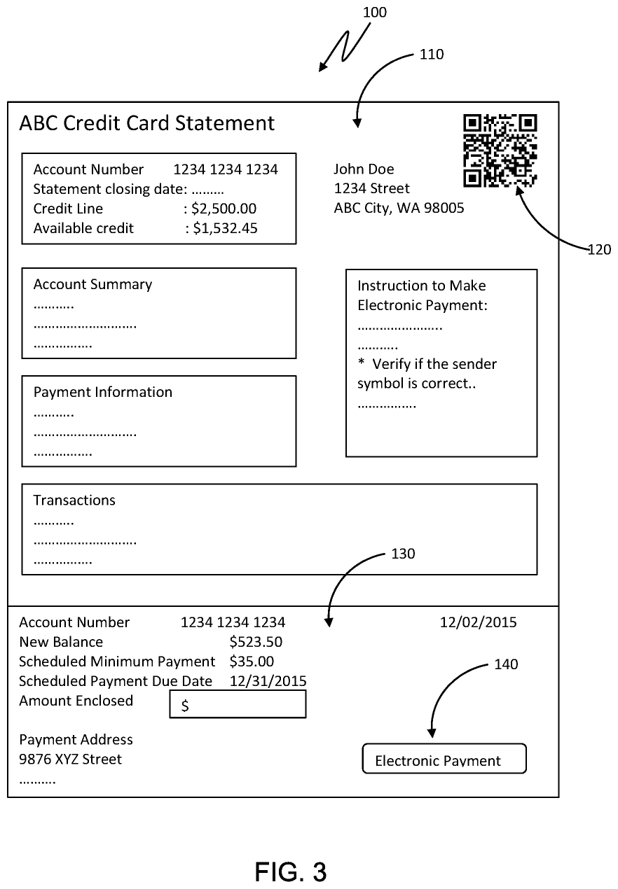

The payer computing device 20 is a typical computing device, like a mobile computer or a desktop computer, that is programmed to send and receive electronic documents. The payer computing device 20 is programmed to receive one or more electronic statements for an individual or business who will make a payment (i.e., the payee). An electronic statement is a document that includes financial information (see FIG. 3). In some examples, an electronic statement can be a credit card statement, a bill or invoice, or other document defining a financial obligation for the individual or business, as described further below.

The biller computing device(s) 40 generate the electronic statements using data, for example, stored in one or more databases 50. The biller computing device(s) 40 deliver the electronic statements to the payer computing device 20, as described further below. In some examples, the biller computing device(s) 40 are controlled by an entity that generates bills or invoices (i.e., a biller), such as a financial institution. One example of a financial institution is a credit card issuer that issues credit cards and generates credit card statements to facilitate payment of credit associated with the credit cards. Another example is a service company, such as a utility company, that provides one or more utilities (e.g., electric, gas, water) for an individual or business and bills the individual or business for the same.

The payee computing device(s) 60 receive payment for the goods and/or services listed on the electronic statements delivered to the payer computing device 20. For example, the payee can be a clothing manufacturer from which the payer purchased some clothing using a credit card issued by the biller. The electronic statement sent by the biller computing devices 40 includes the cost of the clothing. When the payer computing device 20 pays for the clothing listed on the electronic statement as described below, the payment can be made to the biller computing devices 40 or the payee computing device(s) 60.

In some examples, the biller and the payee are the same entity. In such a scenario, the biller computing devices 40 and the payee computing device(s) 60 can be the same. Once such scenario is when the individual or business purchases a good or service from a payee and the payee sends the electronic statement directly to the individual or business.

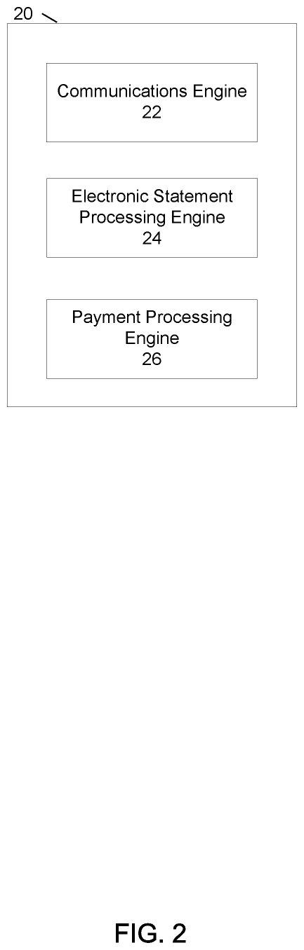

Referring now to FIG. 2, some of the logical components of the payer computing device 20 are shown. These include a communications engine 22, an electronic statement processing engine 24, and a payment processing engine 26.

The communications engine 22 facilitates communication between the payer computing device 20 and the biller computing devices 40. In these examples, the communications engine 22 can encrypt and decrypt each communication to keep it secure. The communications engine 22 is further programmed to identify the electronic statement 100 and forward the electronic statement 100 to the electronic statement processing engine 24.

The electronic statement processing engine 24 is programmed to receive and process the electronic statement 100. In this example, the electronic statement processing engine 24 is programmed to compare the biller identifier in the electronic statement 100 to verify its authenticity. For example, the electronic statement processing engine 24 can compare the biller identifier to a previous identifier provided to the biller to determine if there is a match. The electronic statement processing engine 24 can also identify any actions associated with the electronic statement, such as an amount due on a credit card statement or an invoice.

Payment of the amount due on the electronic statement 100 can be handled by the payment processing engine 26. The payment processing engine 26 is programmed to receive authorization from the payer to pay the amount due on the electronic statement. Upon receipt of authorization, the payment processing engine 26 is programmed to notify the communications engine 22 so the communications engine 22 can encrypt and message the biller to effectuate payment. A new biller identifier can be created by the payment processing engine 26 to accompany that authorization to the biller.

FIG. 3 illustrates an embodiment of an electronic statement 100 that is used in the system 10.

In this example, the electronic statement 100 is issued by the biller computing devices 40, such as a financial institution like a credit card company. The electronic statement 100 is delivered to the payer computing device 20 of the payer associated with the credit card using an electronic communication mechanism, such as email, http, instant messaging, or other electronic communications method.

In this example, the electronic statement 100 includes electronic media content that is intended to be used in either electronic form or printed (hardcopy) form. In some examples, the electronic media content is content other than computer programs, messages, emails, and/or system files that are intended to be used in electronic and/or paper form. An electronic document uses a well-defined format and requires a viewer program to display the content on a computer display or print it on a paper. An example format for the electronic media content of the electronic statement 100 is the Portable Document Format (PDF), which uses a file format that can present documents in a manner independent of application software, hardware, and operating systems. Each PDF file encapsulates a complete description of a fixed-layout flat document, including the text, fonts, graphics and other information needed to display it.

Other electronic document formats can also be used. Examples of such electronic documents include but not limited to Microsoft Word, Excel, and PowerPoint documents, and Adobe Systems' PDF document, which use a proprietary format. There are electronic documents with standardized non-proprietary file formats such as HTML and OpenDocument and other electronic documents for specialized uses have specialized formats, such as Open XML Paper Specification (XPS) format,

In this example, the electronic statement 100 is in a PDF file format. The electronic statement 100 includes a statement section 110 and a billing section 130. The statement section 110 includes an account number, account summary, payment information, transactions history, a biller identifier 120, and the instruction to make payment electronically.

The biller identifier 120 is a unique identifier populated on the electronic statement 100 by the biller computing devices 40. The biller identifier 120 is generated by the payer prior to creation of the electronic statement 100. For example, when the payer establishes an account with the biller (or payee), the payer creates a biller identifier 120, and the biller computing devices 40 store the biller identifier 120 to use in the next statement.

The biller identifier 120 can take various forms. For example, the biller identifier 120 can be a string of alphanumeric characters, numbers, and/or a PIN. The biller identifier 120 can be visualized as a barcode, QR code, image, sound, other symbol or object which can be uniquely identified by the payer computing device 20. When the payer computing device 20 receives the electronic statement 100, the payer and/or the payer computing device 20 can confirm the authenticity of the electronic statement 100 by verifying the biller identifier 120.

In some examples, the verification of the biller identifier 120 may be a machine operation in a payment system of the payer computing device 20 (see the electronic statement processing engine 24). For example, the biller identifier 120 allows the payer computing device 20 to confirm the authenticity of the electronic statement 100 by comparing the biller identifier 120 on the electronic statement with the one identifier previously created by the payer.

As described further, the biller identifier 120 can be cycled each time a payment is made to further enhance security. For example, when a payment is made based upon the electronic statement 100, the payer computing device 20 (or payer him/herself, if desired) produces a new biller identifier and sends the new biller identifier to the biller computing device(s) 40 for use on the next electronic statement.

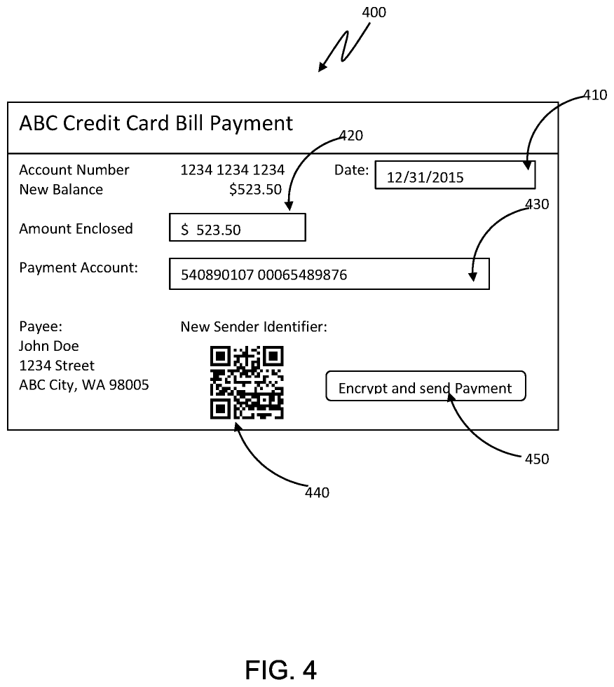

Once the biller identifier 120 is verified, payment can be performed automatically by the payer computing device 20. An example of such an automated payment is provided with respect to the description of FIG. 4.

Alternatively, the payer can manually control one or more of the payment steps. In one example, the payee uses the payer computing device 20 of the electronic statement 100 to select an electronic-payment button 140. This selection, in turn, causes a graphical user interface to be generated on the payer computing device 20 that allows the payer to pay the balance on the electronic statement 100 electronically (see FIG. 4). Or, the payer can print the electronic statement 100, cut out the billing section 130, and mail it with a paper check.

The electronic statement 100 can advantageously allow payers to effectuate payment using multiple methods—print and make payment with checks in the conventional method, submit the payment at a biller's web site, or process the payment from the electronic statement 100 directly (as shown in FIGS. 1 and 4).

FIG. 4 illustrates an embodiment of a statement payment document 400. When the payer selects the electronic-payment button 140 provided on the electronic statement 100, the payer computing device 20 is programmed to generate the statement payment document 400 on the graphical user interface. The statement payment document 400 may be presented as part of the electronic statement 100 or as a separate graphical user interface as depicted in FIG. 4.

The statement payment document 400 includes the billing information, and the payment date 410, total payment 420, the payment account 430 (e.g., a checking account) and other necessary data. This information can be populated automatically from the electronic statement 100 and/or be manually inputted by the payer.

The statement payment document 400 also includes a new biller identifier 440. The new biller identifier 440 can be generated automatically by the payer computing device 20. As noted, the new biller identifier 440 can be a unique string of characters, such as randomly-generated characters. Other identifiers, such as pictures, etc., can be used.

In another example, the new biller identifier 440 can be selected manually by the payer from multiple identifiers presented by on the statement payment document 400. Or, the payer can input a string of characters for the new biller identifier 440 according to certain rules (e.g., length and content requirements).

The new biller identifier 440 can be converted into a visual representation, such as a QR code as depicted in FIG. 4. Other configurations are possible.

Once the statement payment document 400 is complete, the payer selects an encrypt-and-send-payment button 450. When the user selects the encrypt-and-send-payment button 450, the payer computing device 20 uses an encryption scheme, such as the public key generated by the biller and stored in the electronic statement 100, to encrypt the payment information entered by the payer and the new biller identifier 440.

In one embodiment, the payment is executed automatically on the date specified in the bill payment date 410 if a bill payment system is used for making payments automatically. For example, upon receipt of the electronic statement 100, the payer computing device 20 can be programmed to verify the biller identifier. Upon verification, the payer computing device 20 automatically pays the amount associated with the electronic statement 100. The payment can be done immediately or scheduled for a certain time, such as a certain day or a certain period after receipt of the electronic statement 100.

For example, the payer can enter any future date and time in the bill payment date 410, or can enter pay now, or enter pay on due date and save the document. The statement payment document 400 then be used to automatically make payment on the actual date and time per the specified date and time in the bill payment date 410. Once the amount is paid, the statement payment document 400 can provide visible indication (e.g., color coding, notation, etc.) that the amount is paid.

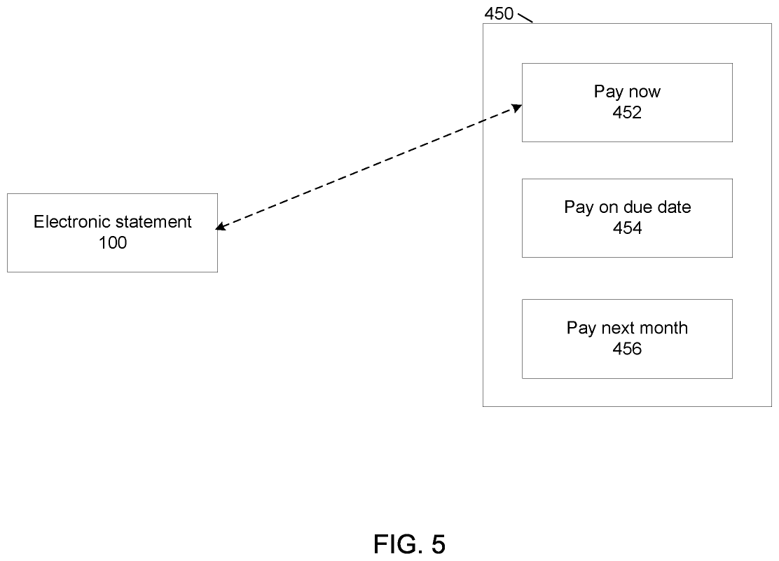

FIG. 5 shows an example user interface 450 that automates the payment date of the electronic statement 100 used in the system of FIG. 1.

In this example, the interface 450 including a plurality of icons, folder, interface items, etc., such as the pay now item 452, the pay on due date item 454, and the pay next month 456. When the user decides to authorize the pay the electronic statement 100, the user can simply drag the electronic statement 100, using an input device such as a mouse or touch, to the appropriate item. In this example, the dashed line shows that the user drags the electronic statement 100 to the pay now item 452. The electronic statement 100 can thereupon be filed in that pay not item 452, like a folder. The electronic statement 100 will also be automatically set for payment now.

Likewise, if the user drags the electronic statement 100 to the pay on due date item 454, the payment will automatically be made on the due date of the electronic statement 100. Finally, if dragged to the pay next month item 456, the payment will automatically be made the following month.

The items 452, 454, 456 can act like folders, in that the user can open each folder, view the statements within each folder, and move statements into and out of each folder as desired. In another example, the items can be formed as a calendar with days, weeks, and months, and the user can simply drop the electronic statement 100 at the desired day on the calendar to set the payment date. Other configurations are possible. For example, in another embodiment, an item can be provided to simply hold the electronic statement 100 for later payment.

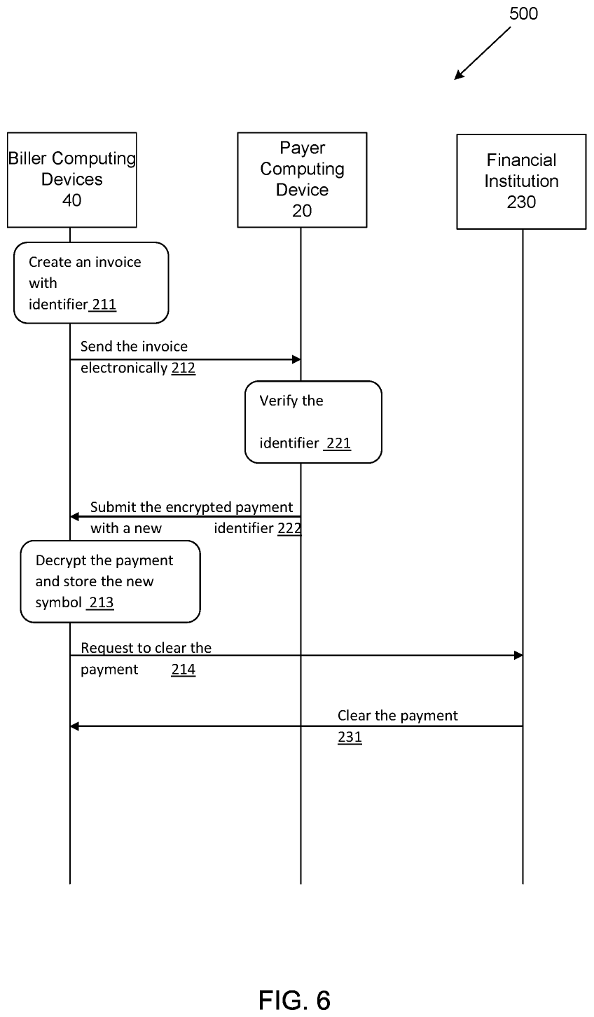

FIG. 6 illustrates an example method 500 of processing electronic payments through the electronic statement. The biller computing device(s) 40, such as a credit card company, merchant, or store, creates an electronic statement (e.g., a bill or invoice) with the biller identifier in step 211. The biller identifier was produced and sent by the payer computing device 20 and stored in by the biller computing device(s) 40 previously (not shown in FIG. 6). The electronic statement also includes a public key and the biller's Internet address (IP) address for the payer computing device 20 to use. The electronic statement is sent to the payer computing device 20 at step 212.

The payer computing device 20 verifies if the biller identifier is the one the payer provided in the previous transaction in step 221. If it is not the right identifier, the payer computing device 20 may treat the electronic statement as a fraudulent statement. If the biller identifier can be authenticated in step 221, the payer computing device 20 submits an encrypted payment as described above in step 222. The biller computing device(s) 40 decrypts the payment and stores the new biller identifier sent by the payer computing device 20 in step 213. The biller computing device(s) 40 request to clear the payment to the payer's financial institution 230 (such as a bank) in step 222. The financial institution 230 clears the payment in step 231.

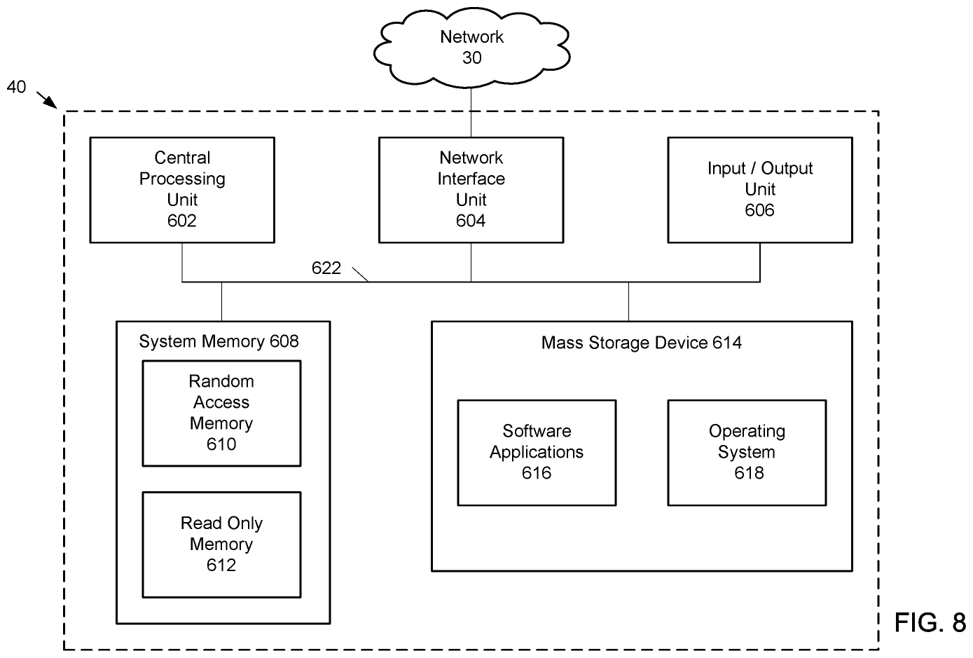

FIG. 8 illustrates an embodiment of the structure of the electronic statement 100. This is one example; the electronic statement can be configured in a multitude of ways.

The electronic statement 100 may use a binary format which is based on the PostScript language and added structure and navigation capabilities. The electronic statement 100 comprises a header 310, a body 320, a cross-reference table 330, and a trailer 340.

The header 310 contains the version number of the electronic statement 100. The version number can include such information as creation date/time of the statement, a versioning of the statement itself, and information associated with the contents of the statement.

The body 320 includes a sequence of indirect objects representing the contents of the document. Exemplary objects are basic types such as fonts, International Color Consortium (ICC) profiles, or the page descriptions. Objects may be stored as compressed streams, and content may be stored and compressed in a range of formats. Filters are used to describe how the data should be decoded. There are general filters and filters specifically intended for images. If encrypted data is contained in the file, the crypto filter may also be present.

The body 320 can also include one or more metadata streams. Metadata streams can be attached at the file level or to any self-contained subassembly object in the file such as a page. The Extensible Metadata Platform (XMP) schemas define how the metadata are stored, including what fields are available. Following the XMP entry, a document information dictionary entry may also exist with much of the same data that was in the XML.

The biller identifier and the public key for encryption are stored in a form of metadata in the body 320 of the electronic statement 100. The public key is used by the biller computing device(s) 40 to encrypt the content of the electronic statement 100 prior to sending it to the payer computing device 20.

The cross-reference table 330 contains information that permits random access to indirect objects within the electronic statement 100 so that the entire file need not be read to locate any particular object. The cross-reference table 330 contains at least a one-line entry for each indirect object, specifying the location of that object within the body of the file.

The trailer 340 can contain such items as a trailer dictionary, a unique identifier for the file, and the end of file marker. The trailer dictionary defines a taxonomy that allows the contents of the electronic statement to grow; for example, the trailer dictionary can be self-describing and allow for new constructs to be added to the system without requiring recompiling. The unique identifier can be string of character and/or numbers that uniquely identify the electronic statement (i.e., a GUID).

Other configurations for the electronic statement are possible. For example, the statement can be delivered in a proprietary format that can be read by a viewer that is programmed to display the financial contents of the electronic statement, as well as to process the biller identifier and effectuate payment.

As illustrated, the biller computing device(s) 40 include at least one central processing unit (“CPU”) 602, a system memory 608, and a system bus 622 that couples the system memory 608 to the CPU 602. The system memory 608 includes a random access memory (“RAM”) 610 and a read-only memory (“ROM”) 612. A basic input/output system that contains the basic routines that help to transfer information between elements within the biller computing device(s) 40, such as during startup, is stored in the ROM 612. The biller computing device(s) 40 further includes a mass storage device 614. The mass storage device 614 is able to store software instructions and data.

The mass storage device 614 is connected to the CPU 602 through a mass storage controller (not shown) connected to the system bus 622. The mass storage device 614 and its associated computer-readable data storage media provide non-volatile, non-transitory storage for the biller computing device(s) 40. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the biller computing device(s) 40.

According to various embodiments of the invention, the biller computing device(s) 40 may operate in a networked environment using logical connections to remote network devices through the network 30, such as a wireless network, the Internet, or another type of network. The biller computing device(s) 40 may connect to the network 30 through a network interface unit 604 connected to the system bus 622. The network interface unit 604 may also be utilized to connect to other types of networks and remote computing systems. The biller computing device(s) 40 also includes an input/output controller 606 for receiving and processing input from a number of other devices, including a touch user interface display screen, or another type of input device. Similarly, the input/output controller 606 may provide output to a touch user interface display screen or other type of output device.

As mentioned briefly above, the mass storage device 614 and the RAM 610 of the biller computing device(s) 40 can store software instructions and data. The software instructions include an operating system 618 suitable for controlling the operation of the biller computing device(s) 40. The mass storage device 614 and/or the RAM 610 also store software applications 616 having instructions that, when executed by the CPU 602, cause the biller computing device(s) 40 to provide the functionality discussed in this document. For example, the mass storage device 614 and/or the RAM 610 can store software instructions that, when executed by the CPU 602, cause the biller computing device(s) 40 to manipulate an electronic statement as described herein.

The other computing devices, such as the payer computing device 20 and the device(s) 60, can be configured in a similar manner.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method for processing an electronic statement, the method comprising:
receiving a biller identifier from a payer prior to generating the electronic statement, the biller identifier being created by the payer and being unique for use in the electronic statement;
generating, by a computing device, the electronic statement, the electronic statement being an electronic document including financial information;
populating, by the computing device, the biller identifier in the electronic statement;
encrypting, by the computing device, the electronic statement including the biller identifier;
sending, by the computing device, the encrypted electronic statement including the biller identifier to the payer;
receiving authorization from the payer to make a payment identified in the electronic statement;
requiring a new biller identifier for each subsequent electronic statement, with the new biller identifier being different from the biller identifier;
generating, by the computing device, a new electronic statement; and
populating, by the computing device, the new biller identifier in the new electronic statement.

2. The method of claim 1, further accepting the biller identifier as a string of characters.

3. The method of claim 2, further comprising displaying the biller identifier on the electronic document.

4. (canceled)

5. The method of claim 1, further comprising forming the electronic statement in a portable document format.

6. The method of claim 5, further comprising displaying the biller identifier on the electronic statement.

7. The method of claim 6, further comprising encoding the biller identifier in a machine-readable code on the electronic statement.

8. The method of claim 7, further comprising selecting the machine-readable code from one of a QR code and a bar code.

9. The method of claim 1, further comprising requesting payment from a financial institution associated with the payer.

10. The method of claim 1, wherein the financial information in the electronic statement is one of a credit card statement and an invoice.

11-19. (canceled)

20. A method for processing an electronic statement, the method comprising:
receiving a biller identifier from a payer prior to generating the electronic statement, the biller identifier being a string of characters created by the payer and being unique for use in the electronic statement;
forming, by a computing device, the electronic statement in a portable document format, the electronic statement being an electronic document being one of a credit card statement and an invoice;
populating, by the computing device, the biller identifier in the electronic statement, the biller identifier being displayed in a readable format on the electronic statement;
encrypting, by the computing device, the electronic statement including the biller identifier;
sending, by the computing device, the encrypted electronic statement including the biller identifier to the payer;
receiving authorization from the payer to make a payment identified in the electronic statement;
requiring a new biller identifier for each subsequent electronic statement, with the new biller identifier being different from the biller identifier;
forming, by the computing device, a new electronic statement; and
populating, by the computing device, the new biller identifier in the new electronic statement.
